(19) United States
(12) Patent Application Publication
(10) Pub. No.: US 2011/0296937 A1
(43) Pub. Date: Dec. 8, 2011

(54) METHOD FOR OPERATING A GROUP TRANSMISSION

(75) Inventor: Martin Miller, Immenstaad (DE)

(73) Assignee: ZF FRIEDRICHSHAFEN AG, Friedrichshafen (DE)

(21) Appl. No.: 13/143,384

(22) PCT Filed: Jan. 8, 2010
(86) PCT No.: PCT/EP2010/050148

§ 371 Date: Jul. 6, 2011

(30) Foreign Application Priority Data
Feb. 20, 2009 (DE) 10 2009 001 030.0

(51) Int. Cl. F16H 61/70; F16H 3/08

(52) U.S. Cl. 74/325

(57) ABSTRACT

A method of operating a group transmission of a motor vehicle, the group transmission being arranged in a drive-train between a drive aggregate and an axle drive and including at least a multi-stage main transmission (HG), a splitter group (GV) connected one of upstream and downstream of the main transmission and/or a range group (GP) connected one of upstream and downstream from the main transmission. The main transmission (HG) is of countershaft design with at least one countershaft (WVG1, WVG2), an input shaft (WGE) of the group transmission is connected to the drive aggregate via a controllable separator clutch (K) and an output shaft (WGA) of the group transmission is connected to the axle drive. For starting the drive aggregate, the splitter group (GV), connected upstream of the main transmission (HG) and/or the range group (GP), connected upstream of the same, is/are shifted to a neutral position.

This application is a National Stage completion of PCT/EP2010/050148 filed Jan. 8, 2010, which claims priority from German patent application serial no. 10 2009 001 030.0 filed Feb. 20, 2009.

### FIELD OF THE INVENTION

The invention concerns a method for operating a group transmission of a motor vehicle.

### BACKGROUND OF THE INVENTION

Group transmissions with a multi-stage main transmission and a range group connected upstream or downstream from the main transmission, as well as a splitter group connected upstream or downstream from the main transmission, have long been known and are preferably used in commercial vehicles. By virtue of a splitter group designed for example with two stages having a gear ratio interval that corresponds approximately to half of an average gear ratio interval between two consecutive gear ratio stages of the main transmission, the gear ratio intervals of the main transmission are halved and the total number of gears of the group transmission available is doubled. By virtue of a range group designed for example with two stages having a gear ratio interval that is above the overall gear ratio interval of the main transmission by approximately an average gear ratio interval between two consecutive gear ratio stages of the main transmission, the ratio spread of the group transmission is approximately doubled and the total number of gears available is again doubled.

FIGS. 1 and 2 show, respectively, a layout of a group transmission of the so-termed AS-Tronic family originated by the present applicant. The group transmission CT shown in FIGS. 1 and 2 comprises a main transmission HG, a splitter group GV in drive connection upstream from the main transmission HG and a range group GP connected downstream from the main transmission HG. The main transmission HG of the group transmission CT in FIGS. 1 and 2 is designed as a direct-gear transmission of countershaft design and comprises a main shaft W_{H} and two countershafts W_{VG1} and W_{VG2}, the first countershaft W_{VG1} being provided with a controllable transmission brake Br.

The main transmission HG is of three-stage design with three gear ratio stages G1, G2 and G3 for forward driving and one gear ratio stage R for driving in reverse. Loose wheels of the gear ratio stages G1, G2 and R are in each case mounted to rotate on the main shaft W_{H} and can be engaged by means of associated claw clutches. The associated fixed wheels are arranged on the countershafts W_{VG1} and W_{VG2} in a rotationally fixed manner.

The highest gear ratio stage G3 of the main transmission HG, made as a direct gear, can be engaged by a direct-shift clutch. The shift clutches of the gear ratio stages G3 and G2 and the shift clutches of the gear ratio stages G1 and R are combined in a common shifting packet, S1 or S2 respectively. The main transmission HG can be shifted without synchronization.

The splitter group GV of the group transmission in FIGS. 1 and 2 is of two-stage design and also of countershaft configuration, such that the two gear ratio steps K1 and K2 of the splitter group form two shiftable input constants of the main transmission HG. The group GV is designed as a splitter group by virtue of a smaller gear ratio difference between the two gear ratio steps K1, K2. The loose wheel of the first gear ratio step K1 is mounted and can rotate on the input shaft W_{GE}, which is connected via a controllable separator clutch K to a drive aggregate (not shown) in the form of an internal combustion engine.

The loose wheel of the second gear ratio step K2 is mounted to rotate on the main shaft W_{H}. The fixed wheels of the two gear ratio steps K1, K2 of the splitter group GV are in each case arranged in a rotationally fixed manner, respectively on extensions of the countershafts W_{VG1} and W_{VG2} of the main transmission on the input side. The shift clutches of the splitter group GV, which are of synchronized design, are combined in a common shifting packet SV. FIG. 1 shows the splitter group GV in the neutral position and FIG. 2 in a force-transmitting position.

The range group GP of the group transmission CT in FIGS. 1 and 2, which is downstream from the main transmission HG, is also of two-stage design but this time of planetary configuration with a simple planetary gearset. The sun gear PS is connected in a rotationally fixed manner to an extension of the main shaft W_{H} of the main transmission HG on the output side. The planetary carrier PT is coupled in a rotationally fixed manner to the output shaft W_{GA} of the group transmission CT. The ring gear PH is connected with a shifting packet SP having two synchronized shift clutches, by means of which the range group GP can be shifted selectively either by connecting the ring gear PH with a fixed part of the housing in a slow-drive stage L, or by connecting the ring gear PH to the main shaft W_{H} or to the sun gear PS in a fast-drive stage S. The range group GP can be shifted with synchronization.

When a motor vehicle with a group transmission CT according to FIGS. 1 and 2 is parked with its drive aggregate switched off, the splitter group GV of the group transmission CT is typically in the force-transmitting position shown in FIG. 2. If the drive aggregate is then to be started, to facilitate its starting the separator clutch K is disengaged, since if when the drive aggregate were started with the splitter group in the force-transmitting position shown in FIG. 2 with the clutch engaged, then numerous wheels and shafts would have to be driven as well, for example the two countershafts W_{VG1} and W_{VG2}. To avoid this, in practice the separator clutch K is disengaged when starting the drive aggregate, namely by means of a clutch control element. At low outside temperatures of less than −20° C. the separator clutch K can sometimes no longer be disengaged by the clutch control element. Since at such low outside temperatures the oil viscosity in the group transmission CT increases, when starting the drive aggregate a large resistance has to be overcome in the group transmission CT, and this is sometimes so large that the drive aggregate can no longer be started at all.

Accordingly, a method is needed for operating a group transmission of a drive-train of a motor vehicle, by virtue of which reliable starting of the drive aggregate can be ensured even at low outside temperatures.

From DE 197 26 567 A1 a method for operating a group transmission of a motor vehicle is known, with which the main shaft of the group transmission can be synchronized when carrying out a shift operation.

DE 103 25 666 A1 discloses a method for operating a conventional transmission of a motor vehicle, such that to protect the transmission during cold starting certain functionalities of the transmission are selectively restricted as a function of a temperature stage.

### SUMMARY OF THE INVENTION

Starting from there, the present invention addresses the problem of providing a new type of method for operating a group transmission of a motor vehicle.

In a first aspect of the invention to start the drive aggregate, the splitter group and/or the range group connected upstream from the main transmission is shifted to a neutral position.

According to a second aspect of the invention when the drive aggregate is stopped the splitter group and/or the range group connected upstream from the main transmission is/are shifted to a neutral position.

The common feature of the two aspects of the present invention is that the splitter group connected upstream from the main transmission and/or the range group connected upstream from the same is/are shifted to the neutral position, in order to ensure problem-free starting of the drive aggregate of the drive-train comprising the group transmission, even in low outside temperatures.

According to the first aspect of the present invention, to start the drive aggregate the splitter group and/or the range group connected upstream from the main transmission is/are shifted to the neutral position, and this is preferably done after igniting the drive aggregate. According to the second aspect of the present invention, when the drive aggregate is stopped the splitter group and/or the range group connected upstream from the main transmission is/are shifted to the neutral position.

### BRIEF DESCRIPTION OF THE DRAWINGS

Preferred further developments of the invention emerge from the description given below. An example embodiment of the invention, to which it is not limited, is explained in more detail with reference to the drawings, which show:

FIG. 1: Layout of a group transmission in a first shift condition of the splitter group; and

FIG. 2: Layout of a group transmission in a second shift condition of the splitter group.

### DETAILED DESCRIPTION OF THE PREFERRED EMBODIMENTS

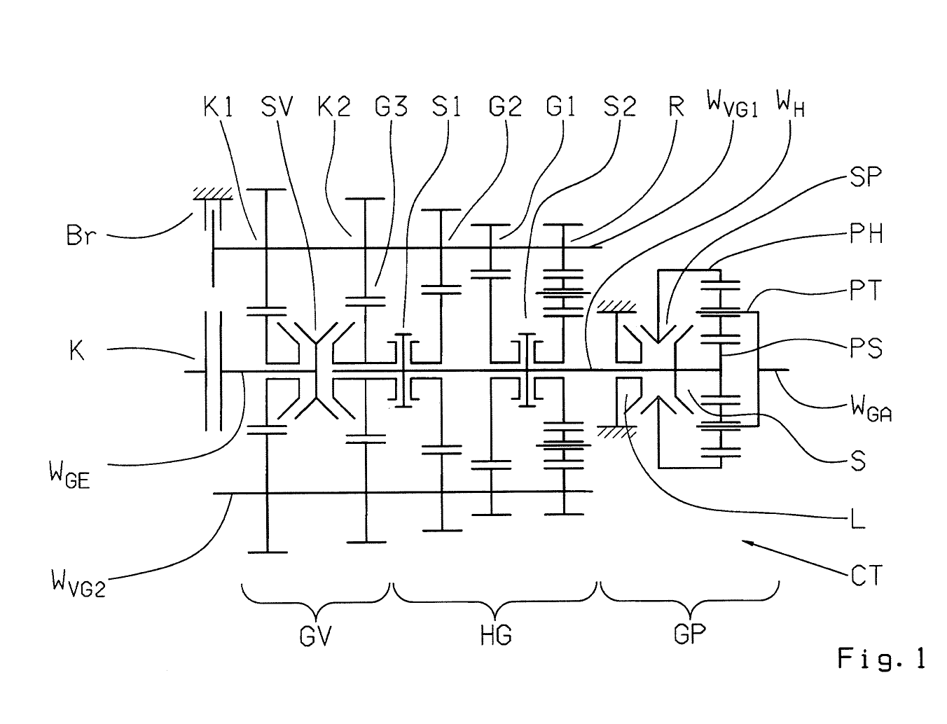

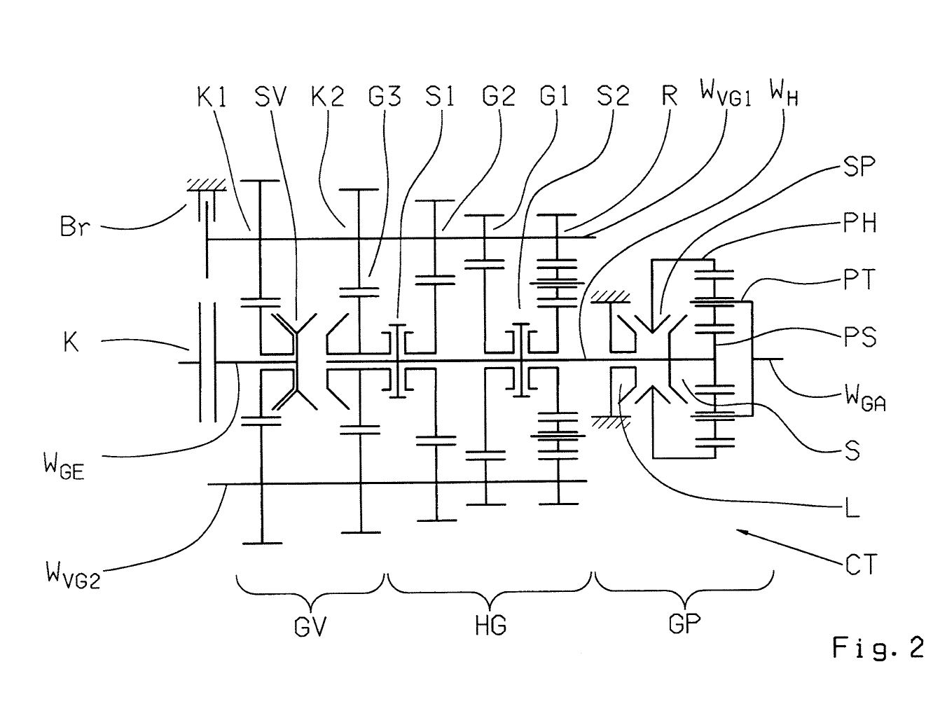

The present invention concerns a method for operating a group transmission of a motor vehicle, in particular the semi-automatic group transmission CT already described in detail and shown in FIGS. 1 and 2. The method according to the invention concerns such details by virtue of which a drive aggregate can be started without problems.

In a first aspect of the present invention, when a drive-train comprising a drive aggregate and a group transmission CT in particular according to FIGS. 1 and 2 is to be started, to start the drive aggregate the splitter group GV connected upstream from the main transmission HG is shifted to a neutral position. This ensures that to start the drive aggregate, the shafts and wheels in the transmission that also have to be rotated are reduced to an absolute minimum so as to minimize the resistance of the group transmission CT when starting the drive aggregate.

According to a first advantageous further development of the first aspect of the present invention, to start the drive aggregate the splitter group GV connected upstream from the main transmission HG is shifted to the neutral position as in FIG. 1 exclusively when defined operating conditions of the drive-train exist. For example, it can be provided that the splitter group GV is only shifted to the neutral position shown in FIG. 1 for starting the drive aggregate if, when starting the drive aggregate, an outside temperature or a temperature of the transmission is lower than a defined limit value, for example lower than −20° C. Alternatively or in addition the splitter group GV can be shifted to the neutral position for starting the drive aggregate if, when starting the drive aggregate, the separator clutch K cannot be disengaged, this being detectable for example with the help of a sensor associated with the separator clutch K which monitors the position of the separator clutch K. Alternatively or in addition, the splitter group GV can be shifted to a neutral position for starting the drive aggregate if, in a previous starting process, the drive aggregate could not be started.

According to a second advantageous further development of the first aspect of the present invention, the splitter group GV connected upstream from the main transmission HG can be shifted to the neutral position shown in FIG. 1 for every starting process of the drive aggregate.

The splitter group GV is shifted to the neutral position for starting the drive aggregate in accordance with the first aspect of the invention, in each case after the drive aggregate has been ignited.

Thus, according to the first aspect of the present invention, to start a drive aggregate the splitter group GV of the group transmission CT is shifted to the neutral position of FIG. 1. A starter motor then only still has to drive the input shaft W_{GE} of the group transmission CT together with the driving disk and a bearing (not shown). In contrast the countershafts W_{VG1} and W_{VG2} and all the wheels and bearings that mesh with the countershaft gearing remain static, whereby the resistance offered by the group transmission CT when the drive aggregate is started can be greatly reduced.

Preferably, for starting the drive aggregate the splitter group GV is shifted to neutral at low outside temperatures or low transmission temperatures which are under a predetermined temperature limit value. When a motor vehicle has been stopped for a long time the transmission temperature corresponds approximately to the outside temperature.

If a range group is connected upstream from the main transmission HG, to start the drive aggregate the range group is shifted to the neutral position. If more than one group, for example a splitter group and a range group are connected upstream from the main transmission HG, then for starting the drive aggregate at least that group is shifted to the neutral position whose shifting packet is coupled, via the input shaft of the group transmission, to a driving disk of the separator clutch K. In FIGS. 1 and 2 this is the case for the shifting packet SV of the splitter group GV.

According to a second aspect of the present invention, whenever the drive aggregate is stopped the splitter group GV connected upstream from the main transmission is shifted to the neutral position.

In a first advantageous further development of the second aspect of the present invention this can take place exclusively if certain defined operating conditions of the drive-train exist, or, according to a second advantageous further development of the second aspect of the invention, it can take place each time the drive aggregate is stopped. If the splitter group GV is shifted to the neutral position exclusively when defined operating conditions of the drive-train exist, this is done if, when the motor vehicle and therefore the drive aggregate are stopped, the outside temperature is lower than a defined limit value, for example lower than −20° C. In this way it can be ensured that during a subsequent start of the drive aggregate the splitter group GV of the group transmission CT is already in the neutral position, and therefore that when the drive aggregate is started, only a small resistance of the group transmission CT has to be overcome.

In the event that, when implementing the first advantageous further development of the second aspect of the present invention, the motor vehicle has no temperature sensor of its own for measuring the outside temperature, then when the drive aggregate is started the temperature of the transmission, which when starting the drive aggregate corresponds approximately to the outside temperature, can be stored, so that when the drive aggregate is next stopped, the splitter group GV of the group transmission CT can be shifted to the neutral position if the temperature stored when the drive aggregate was last started is lower than the defined, predetermined limit value. On the other hand, if the motor vehicle does have a separate outside temperature sensor, the splitter group GV can be shifted to the neutral position as a function of the outside temperature measured by the sensor.

In accordance with the first aspect of the present invention, the second aspect of the invention can also be used with group transmissions in which a range group, or a splitter group and a range group, are connected upstream from the main transmission thereof. When a range group is connected upstream from the main transmission HG, the range group is shifted to the neutral position when the drive aggregate is stopped. If more than one group are connected upstream from the main transmission HG, for example a splitter group and a range group, then when the drive aggregate is stopped at least that group is shifted to the neutral position whose shifting packet is coupled to a driving disk of the separator clutch K by the input shaft of the group transmission. This is the case for the shifting packet SV of the splitter group GV in FIGS. 1 and 2.

1-11. (canceled)

12. A method of operating a group transmission of a motor vehicle, the group transmission being arranged in a drive-train between a drive aggregate and an axle drive and comprising at least a multi-stage main transmission (HG), and at least one of a splitter group (GV) being connected one of upstream and downstream of the main transmission and a range group (GP) being connected one of upstream and downstream of the main transmission, the main transmission (HG) being of countershaft design with at least one countershaft (W_{VG1}, W_{VG2}), an input shaft (W_{GE}) of the group transmission being connected to the drive aggregate via a controllable separator clutch (K) and an output shaft (W_{GA}) of the group transmission being connected to an axle drive, the method comprising the steps of:
when starting the drive aggregate, shifting at least one of the splitter group (GV), connected upstream of the main transmission (HG), and the range group (GP), connected upstream of the main transmission (HG), to a neutral position.

13. The method according to claim 12, further comprising the step of shifting the at least one of the splitter group (GV), connected upstream of the main transmission (HG), and the range group (GP), connected upstream of the main transmission (HG), to the neutral position exclusively when defined operating conditions of the drive-train exist.

14. The method according to claim 13, further comprising the step of shifting the at least one of the splitter group (GV), connected upstream of the main transmission (HG), and the range group (GP), connected upstream of the main transmission (HG), to the neutral position if one of an outside temperature and a transmission temperature is lower than a defined limit value.

15. The method according to claim 13, further comprising the step of shifting the at least one of the splitter group (GV), connected upstream of the main transmission (HG), and the range group (GP), connected upstream of the main transmission (HG), to the neutral position if the separator clutch (K) cannot be opened.

16. The method according to claim 13, further comprising the step of shifting the at least one of the splitter group (GV), connected upstream of the main transmission (HG), and the range group (GP) connected upstream of the main transmission (HG), to the neutral position if the drive aggregate could not be started during a previous starting process.

17. The method according to claim 12, further comprising the step of shifting the at least one of the splitter group (GV), connected upstream of the main transmission (HG), and the range group (GP), connected upstream of the main transmission (HG), to the neutral position each time the drive aggregate is started.

18. The method according to claim 12, further comprising the step of shifting the at least one of the splitter group (GV), connected upstream of the main transmission (HG), and the range group (GP), connected upstream of the main transmission (HG), to the neutral position after ignition of the drive aggregate.

19. A method of operating a group transmission of a motor vehicle, the group transmission being arranged in a drive-train between a drive aggregate and an axle drive and comprising at least a multi-stage main transmission (HG), at least one of a splitter group (GV) connected one of upstream and downstream of the main transmission and a range group (GP) connected one of upstream and downstream of the main transmission, the main transmission (HG) is of a countershaft design with at least one countershaft (W_{VG1}, W_{VG2}), an input shaft (W_{GE}) of the group transmission is connected to the drive aggregate via a controllable separator clutch (K) and an output shaft (W_{GA}) of the group transmission is connected to the axle drive, the method comprising the steps of:
shifting the at least one of the splitter group (GV) connected upstream of the main transmission (HG) and the range group (GP) connected upstream of the main transmission (HG) to a neutral position when the drive aggregate is stopped.

20. The method according to claim 19, further comprising the step of shifting the at least one of the splitter group (GV), connected upstream of the main transmission (HG), and the range group (GP), connected upstream of the main transmission (HG), to a neutral position exclusively when the drive aggregate is stopped and when defined operating conditions of the drive-train exist.

21. The method according to claim 20, further comprising the step of shifting the at least one of the splitter group (GV), connected upstream of the main transmission (HG), and the range group (GP), connected upstream of the main transmission (HG), to the neutral position, when the drive aggregate is stopped, and if an outside temperature is lower than a defined limit value.

22. The method according to claim 19, further comprising the step of shifting the at least one of the splitter group (GV), connected upstream of the main transmission (HG), and the range group (GP), connected upstream of the main transmission (HG), to a neutral position each time the drive aggregate is stopped.

23. A method of operating a group transmission of a motor vehicle, the group transmission being arranged in a drive-train between a drive aggregate and an axle drive and comprising at least a multi-stage main transmission (HG), and at least one of a splitter group (GV) and a range group (GP) being connected upstream of the main transmission, another of the splitter group (GV) and the range group (GP) being connected downstream of the main transmission, the main transmission (HG) being of countershaft design with at least one countershaft (W_{VG1}, W_{VG2}) an input shaft (W_{GE}) of the group transmission being connected to the drive aggregate via a controllable separator clutch (K) and an output shaft (W_{GA}) of the group transmission being connected to an axle drive, the method comprising the steps of:
when starting the drive aggregate, shifting at least one of the splitter group (GV), connected upstream of the main transmission (HG), and the range group (GP), connected upstream of the main transmission (HG), to a neutral position.
